(19) United States
(12) Patent Application Publication
(10) Pub. No.: US 2012/0139453 A1
(43) Pub. Date: Jun. 7, 2012

(54) LAMP CAPABLE OF TURNING OFF ON ITS OWN

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/300,624

(22) Filed: Nov. 20, 2011

(30) Foreign Application Priority Data
Dec. 1, 2010 (TW) 099141812

(51) Int. Cl. H05B 37/02

(52) U.S. Cl. 315/362

(57) ABSTRACT

A lamp includes a ring, a first housing and a second housing connected to two opposite ends of the ring and a light emitting pipe. The ring defines a through hole through which the light emitting pipe extends. The first housing and the second housing each include a lampshade connected to the ring, a cover connected to the lampshade and a pressure detecting element fixed on the cover. A quantity of powder is received in the first housing and the second housing. The powder can flow between the first housing and the second housing through the through hole. The pressure detecting elements can detect the weight of the powder accumulated thereon to turn the light emitting pipe on or off.

### BACKGROUND

1. Technical Field

The present disclosure relates to lamps, and more particularly, to a lamp capable of being automatically turned off.

2. Description of Related Art

Generally, people likes to read books before sleep, lamps thus are placed beside beds for lighting. However, some times people may fall asleep during reading books and forget to turn the lamps off. Thus, the lamps will keep lighten for a long time until people wake up. The continuous operation of the lamps wastes electrical energy.

What is needed, therefore, is a lamp which can overcome the deficiencies as described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled view of a lamp in accordance with an embodiment of the present disclosure.

FIG. 2 is an exploded view of the lamp of FIG. 1.

FIG. 3 is an inverted view of the lamp of FIG. 2.

### DETAILED DESCRIPTION OF THE EMBODIMENTS

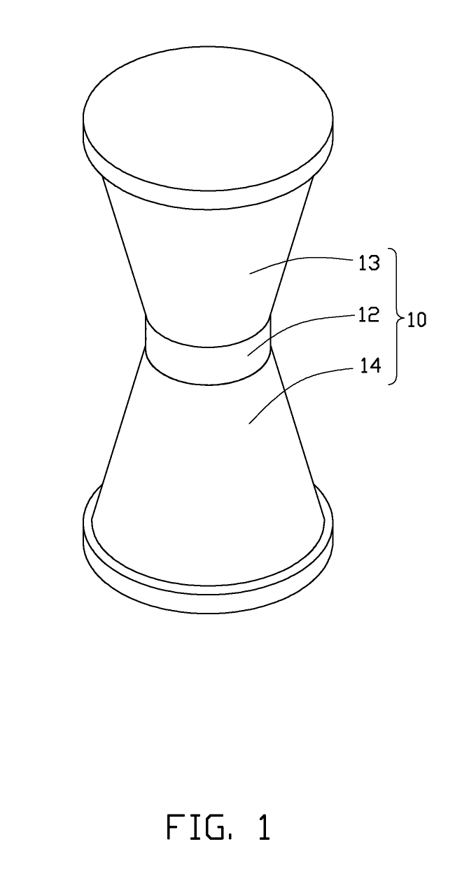

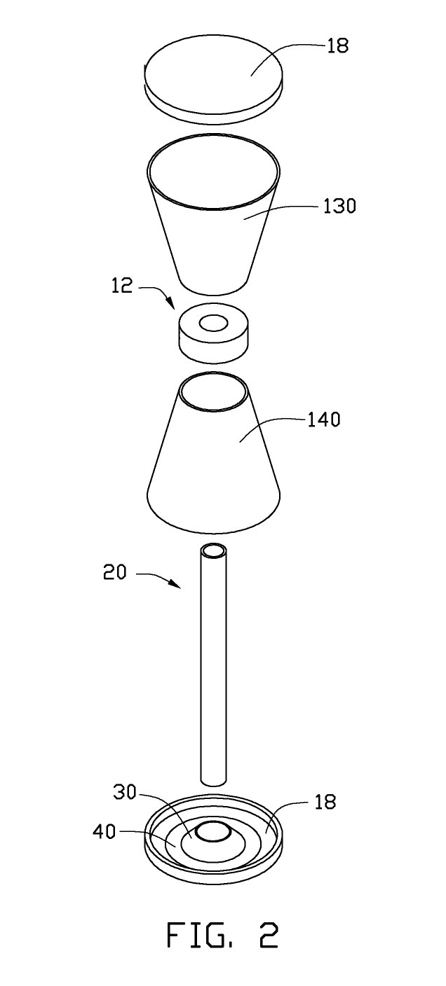

Referring to FIGS. 1-2, a lamp 10 in according with an embodiment of the present disclosure is shown. The lamp has a shape like funnel having two large opposite ends and a small middle. The lamp includes a ring 12, a first housing 13 and a second housing 14 fixed to a top and a bottom of the ring 12, respectively, and a light emitting pipe 20 extending through the ring 12 and received in the first and second housings 13, 14.

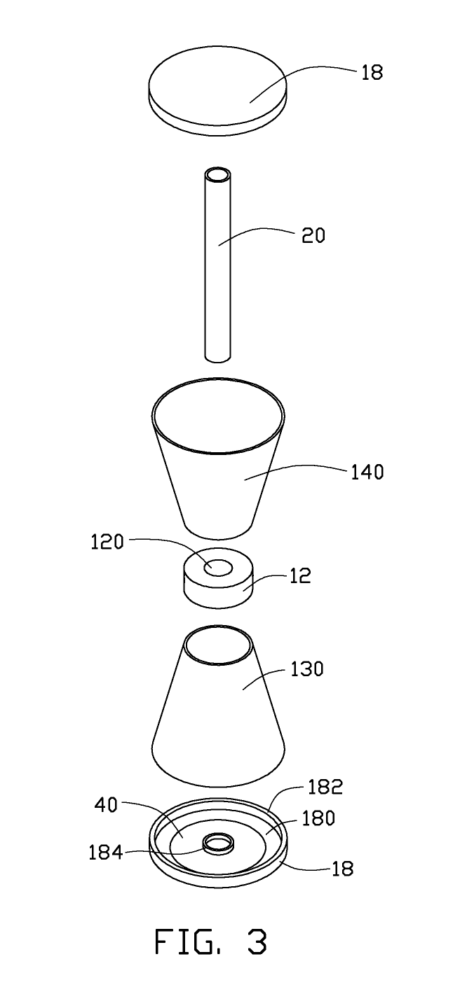

Also referring to FIG. 3, the ring 12 defines a through hole 120 in a center thereof. A diameter of the through hole 120 may be variable following rotation of the ring 12 relative to the first housing 13 and the second housing 14. Such variation of the diameter of the through hole 120 in response to rotation of the ring 12 may be realized by known methods in the art.

The first housing 13 and the second housing 14 have the same configurations, so only one (the first housing 13) would be discussed below for brevity. The first housing 13 includes a lampshade 130 connected to the ring 12 and a cover 18 connected to the lampshade 130. The lampshade 130 may be made of transparent materials such as glass or epoxy. The lampshade 130 is hollow and has a diameter gradually increasing from the ring 12 towards the cover 18. The lampshade 130 has a small end fixed to the ring 12 and a large end fixed to the cover 18. An interior space of the lampshade 130 communicates with the through hole 120 of the ring 12. The cover 18 includes a plate 180 and a sidewall 182 extending from the plate 180 towards the ring 12. The plate 180 has a circular profile and the sidewall 182 surrounds the plate 180. The sidewall 182 is sleeved on the large end of the lampshade 130 to fix the cover 18 to the lampshade 130, while the plate 180 seals the large end of the lampshade 130. An annular protrusion 184 protrudes from a center of the plate 180 towards the ring 12. The annular protrusion 184 has a diameter much less than that of the sidewall 182. A pressure detecting element 40 is fixed on an inner side of the plate 180. The pressure detecting element 40 has an annular shape and surrounds the annular protrusion 184. The pressure detecting element 40 can detect weight of an object disposed thereon and produce a signal to control lighting of the light emitting pipe 20.

The light emitting pipe 20 may be a fluorescent tube, a transparent pipe having LEDs (light emitting diodes) received therein or other suitable light sources. The light emitting pipe 20 has an outer diameter less than a diameter of the through hole 120 of the ring 12, whereby when the light emitting pipe 20 extends through the through hole 120 of the ring 12, an outer circumferential part of the through hole 120 can still retain empty without block by the light emitting pipe 20. As rotation of the ring 12, the empty outer circumferential part of the through hole 120 can be changed. Two opposite ends of the light emitting pipe 20 are respectively aligned with the two annular protrusions 184 of the first housing 13 and the second housing 14. The two opposite ends of the light emitting pipe 20 are spaced distances from the two annular protrusions 184 and connected to the two annular protrusions 184 via fasteners (not shown) which do not substantially seal spaces between the two opposite ends of the light emitting pipe 20 and the two annular protrusions 184. The light emitting pipe 20 is electrically connected to the two pressure detecting elements 40. The light emitting pipe 20 can be turned on or off according to the signals of the two pressure detecting elements 40.

A quantity of fluid 30 is placed on the pressure detecting element 40 of one of the first housing 13 and second housing 14. As shown in FIG. 2, the quantity of fluid 30 is disposed on the pressure detecting element 40 of the second housing 14 which is located under the first housing 13. The fluid 30 may be liquid or powder having a predetermined color, such as red or blue, depending on the actual requirements. The quantity of fluid 30 may flow from the one of the first and second housing 13, 14 to the other one of the first and second housing 13, 14 through the empty outer circumferential part of the through hole 120. In this embodiment, the fluid 30 is powder and accumulated in a shape of dune as shown in FIG. 2. The pressure detecting element 40 is set to produce a signal when detecting the quantity of the fluid 30 accumulated thereon over a predetermined weight, preferably, 80% total weight of the fluid 30. The light emitting pipe 20 is automatically turned off in response to the signal. When the pressure detecting element 40 detects the weight of the fluid 30 accumulated thereon less than the predetermined value, it does not produce any signal and the light emitting pipe 20 keeps lightening.

In use, the lamp 10 is inverted to make the housing 14 with the fluid 30 up while the housing 13 without the fluid 30 down. Under the action of gravity, the fluid 30 falls off from the second housing 14 onto the pressure detecting element 40 of the first housing 13, the pressure detecting element 40 of the first housing 13 detects weight of the fluid 30 and thus stops producing the signal to the light emitting pipe 20. The light emitting pipe 20 is lighten until the fluid 30 in the first housing 13 reaches the predetermined value, i.e., 80% total weight thereof, at which, the pressure detecting element 40 of the first housing 13 produces the signal to the light emitting pipe 20 to turn it off. Therefore, the lamp 10 is automatically switched from on to off.

When the fluid 30 in the first housing 13, the lamp should be kept with the first housing 13 over the second housing 14 for using. Similarly, the fluid 30 flows from the first housing 13 into the second housing 14, and the pressure detecting element 40 of the second housing 14 controls lighting of the light emitting pipe 20 according to the fluid 30 thereon. By adjusting the size of the empty outer circumferential part of the through hole 120 between the ring 12 and the light emitting pipe 20, a flowing speed of the fluid 30 can be controlled, and the period from on to off status of the light emitting pipe 20 can be controlled accordingly.

Furthermore, if the lamp 10 is required to keep illumination all the time, the ring 12 can be rotated to substantially close the passage of the powder 30 between the first housing 13 and the second housing 14, i.e., enabling an inner circumferential periphery of the ring 12 tightly abutting against an outer circumferential periphery of the light emitting pipe 20. The powder 30 in the first housing 13 or the second housing 14 can fall and be blocked on a surface of the ring 12.

In addition, a piezoelectric material may be incorporated within the pressure detecting element 40. When the powder 30 falls on the pressure detecting element 40, the piezoelectric material can produce power subject to the pressure of the powder 30. The power generated by the piezoelectric material can be further delivered to the light emitting pipe 20 to drive the light emitting pipe 20 to lighten.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A lamp comprising:
a ring having a through hole;
a first housing and a second housing connected to two opposite ends of the ring, the first housing comprising a pressure detecting element mounted therein;
a quantity of fluid being received in and movable between the first housing and the second housing through the through hole of the ring; and
a light source electrically connected to the pressure detecting element;
wherein the lamp is operable to locate the second housing above the first housing, the fluid flowing through the through hole from the second housing to the first housing and being accumulated on the pressure detecting element under gravity, the pressure detecting element turning the light source from on to off when weight of the fluid accumulated on the pressure detecting element reaching a predetermined value.

2. The lamp of claim 1, wherein the ring is rotatable relative to the first housing and the second housing to adjust a diameter of the through hole.

3. The lamp of claim 1, wherein the light source comprises a light emitting pipe extending through the through hole of the ring.

4. The lamp of claim 3, wherein the light emitting pipe has an outer diameter less than the diameter of the through hole.

5. The lamp of claim 1, wherein each of the first housing and the second housing comprises a lampshade connected to the ring and a cover connected to the lampshade, the lampshade being located between the ring and a corresponding cover connected thereto.

6. The lamp of claim 5, wherein the lampshade has a diameter gradually increasing from the ring towards the cover connected thereto.

7. The lamp of claim 5, wherein the pressure detecting element is fixed on the cover of the first housing.

8. The lamp of claim 5, wherein the second housing also comprises a pressure detecting element fixed on the cover thereof.

9. The lamp of claim 8, wherein each of the pressure detecting elements produces a signal to turn the light source off when detecting the weight of the fluid accumulated thereon over the predetermined value, and produces no signal to the light source when detecting the weight of the fluid accumulated thereon is less than the predetermined value, the light source keeping lighten when receiving no signal.

10. The lamp of claim 1, wherein the fluid comprises powder.

11. The lamp of claim 1, wherein the pressure detecting element comprises piezoelectric material.

12. A lamp comprising:
a ring having a through hole;
a light source extending through the through hole of the ring, an empty space being formed between the light source and the ring within the through hole;
a first housing and a second housing respectively fixed to two opposite ends of the ring;
a pressure detecting element received in the first housing and electrically connected to the light source; and
a quantity of fluid being movable from the second housing into the first housing through the empty space, to thereby fall on the pressure detecting element;
wherein the pressure detecting element turns the light source on or off according to the weight of the fluid falling thereon.

13. The lamp of claim 12, wherein the light source comprises a light emitting pipe having two opposite ends received in the first housing and the second housing, respectively.

14. The lamp of claim 12, wherein each of the first housing and the second housing comprises a cover and a lampshade connected between the cover and the ring, the pressure detecting element being fixed on the cover of the first housing.

15. The lamp of claim 14, wherein the lampshade has a diameter gradually increasing from the ring towards the cover connected thereto.

16. The lamp of claim 14, wherein the second housing comprises another pressure detecting element fixed on the cover thereof and electrically connected to the light source.

17. The lamp of claim 12, wherein a volume of the empty space is variable according to rotation of the ring relative to the first housing and the second housing.

18. The lamp of claim 12, wherein the pressure detecting element comprises piezoelectric material.
